(19) United States
(12) Patent Application Publication
(10) Pub. No.: US 2010/0118564 A1
(43) Pub. Date: May 13, 2010

(54) Custom assembly light-emitting module using plugs and jacks for obtaining vertical electrical connections

(76) Inventors: Che-Cheng Shen, Banciao City (TW); Yen-Fu Liu, Tucheng City (TW); Ching-Kun Chang, Taipei City (TW); Kuo-Hsin Yeh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,062

(22) Filed: Nov. 12, 2008

(51) Int. Cl. H01R 33/00

(52) U.S. Cl. 362/647

(57) ABSTRACT

A custom assembly light-emitting module using plugs and jacks for obtaining vertical electrical connections, includes a light-emitting unit, a lens unit, a plug unit and a jack unit. The lens unit is detachably combined with the light-emitting unit. The plug unit is disposed beside one side of the lens unit and electrically connected with the light-emitting unit. The jack unit is disposed on a bottom side of the plug unit and electrically connected with the plug unit. In addition, the light-emitting unit has two first retaining structures being formed on two opposite lateral sides thereof, the lens unit has a hollow transparent structure and a lens integratedly with the hollow transparent structure, two second retaining structures are disposed in the hollow transparent structure, and the light-emitting unit is detachably disposed in the hollow transparent structure.

### BACKGROUND OF THE INVENTION

1. Field of the Invention

The present invention relates to a light-emitting module, and particularly relates to a custom assembly light-emitting module using plugs and jacks for obtaining vertical electrical connections.

2. Description of Related Art

A traditional light-emitting device is used to provide illumination for humans, such as general illumination or illumination for enhancing the aspect of the environment. However, the characteristics of traditional light-emitting devices are fixed such as fixed heat-dissipating effect, fixed light-emitting effect, and fixed light-projecting angle.

When the user purchases a traditional light-emitting device, the components of the traditional light-emitting device cannot be replaced. In other words, because the characteristics of a traditional light-emitting device are fixed, the components of the traditional light-emitting device cannot be replaced according to the different user requirements.

### SUMMARY OF THE INVENTION

One particular aspect of the present invention is to provide a custom assembly light-emitting module using plugs and jacks for obtaining vertical electrical connections that include a light-emitting unit and a lens unit that are replaceable according to the different user requirements. Hence, the light-emitting unit is replaceable according to different light-emitting effects, and the lens unit is replaceable according to different light-projecting angles. Moreover, the present invention has vertical electrical connections by matching a plug unit (plug pins) and a jack unit (jack pins).

In order to achieve the above-mentioned aspects, the present invention provides a custom assembly light-emitting module using plugs and jacks for obtaining vertical electrical connections, including: a light-emitting unit, a lens unit, a plug unit and a jack unit. The lens unit is detachably combined with the light-emitting unit. The plug unit is disposed beside one side of the lens unit and electrically connected with the light-emitting unit. The jack unit is disposed on a bottom side of the plug unit and electrically connected with the plug unit. In addition, the light-emitting unit has two first retaining structures respectively extended upwards from two opposite lateral sides thereof, the lens unit has a lens and two second retaining structures respectively formed on two opposite lateral sides of the lens, and the lens unit is detachably disposed above the light-emitting unit by matching the two first retaining structures and the two second retaining structures.

In order to achieve the above-mentioned aspects, the present invention provides a custom assembly light-emitting module using plugs and jacks for obtaining vertical electrical connections, including: a light-emitting unit, a lens unit, a plug unit and a jack unit. The lens unit is detachably combined with the light-emitting unit. The plug unit is disposed beside one side of the lens unit and electrically connected with the light-emitting unit. The jack unit is disposed on a bottom side of the plug unit and electrically connected with the plug unit. In addition, the light-emitting unit has two first retaining structures disposed on two opposite lateral sides thereof, the lens unit has a lens and two second retaining structures respectively extended downwards from two opposite lateral sides of the lens, and the lens unit is detachably disposed above the light-emitting unit by matching the two first retaining structures and the two second retaining structures.

In order to achieve the above-mentioned aspects, the present invention provides a custom assembly light-emitting module using plugs and jacks for obtaining vertical electrical connections, including: a light-emitting unit, a lens unit, a plug unit and a jack unit. The lens unit is detachably combined with the light-emitting unit. The plug unit is disposed beside one side of the lens unit and electrically connected with the light-emitting unit. The jack unit is disposed on a bottom side of the plug unit and electrically connected with the plug unit. In addition, the light-emitting unit has two first retaining structures are formed on two opposite lateral sides thereof, the lens unit has a hollow transparent structure and a lens integratedly with the hollow transparent structure, two second retaining structures are disposed in the hollow transparent structure, and the light-emitting unit is detachably disposed in the hollow transparent structure.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1A is a perspective, exploded view of a custom assembly light-emitting module using plugs and jacks for obtaining vertical electrical connections according to the first embodiment of the present invention;

FIG. 1B is a perspective, assembled view of a custom assembly light-emitting module using plugs and jacks for obtaining vertical electrical connections according to the first embodiment of the present invention;

FIG. 1C is a lateral, schematic view of a custom assembly light-emitting module using plugs and jacks for obtaining vertical electrical connections according to the first embodiment of the present invention;

FIG. 1D is a lateral, schematic view of a custom assembly light-emitting module using plugs and jacks for obtaining vertical electrical connections fixed by a hooking unit according to the first embodiment of the present invention;

FIG. 1E is a perspective, exploded view of a custom assembly light-emitting module using plugs and jacks for obtaining vertical electrical connections according to the first embodiment of the present invention;

FIG. 2A is a perspective, exploded view of a custom assembly light-emitting module using plugs and jacks for obtaining vertical electrical connections according to the second embodiment of the present invention;

FIG. 2B is a perspective, assembled view of a custom assembly light-emitting module using plugs and jacks for obtaining vertical electrical connections according to the second embodiment of the present invention;

FIG. 2C is a lateral, schematic view of a custom assembly light-emitting module using plugs and jacks for obtaining vertical electrical connections fixed by a hooking unit according to the second embodiment of the present invention;

FIG. 2D is a perspective, exploded view of a custom assembly light-emitting module using plugs and jacks for obtaining vertical electrical connections according to the second embodiment of the present invention;

FIG. 3A is a perspective, exploded view of a custom assembly light-emitting module using plugs and jacks for obtaining vertical electrical connections according to the third embodiment of the present invention;

FIG. 3B is a perspective, assembled view of a custom assembly light-emitting module using plugs and jacks for obtaining vertical electrical connections according to the third embodiment of the present invention; and

FIG. 3C is a lateral, schematic view of a custom assembly light-emitting module using plugs and jacks for obtaining vertical electrical connections fixed by a hooking unit according to the third embodiment of the present invention; and

FIG. 3D is a perspective, exploded view of a custom assembly light-emitting module using plugs and jacks for obtaining vertical electrical connections according to the third embodiment of the present invention.

### DETAILED DESCRIPTION OF PREFERRED EMBODIMENTS

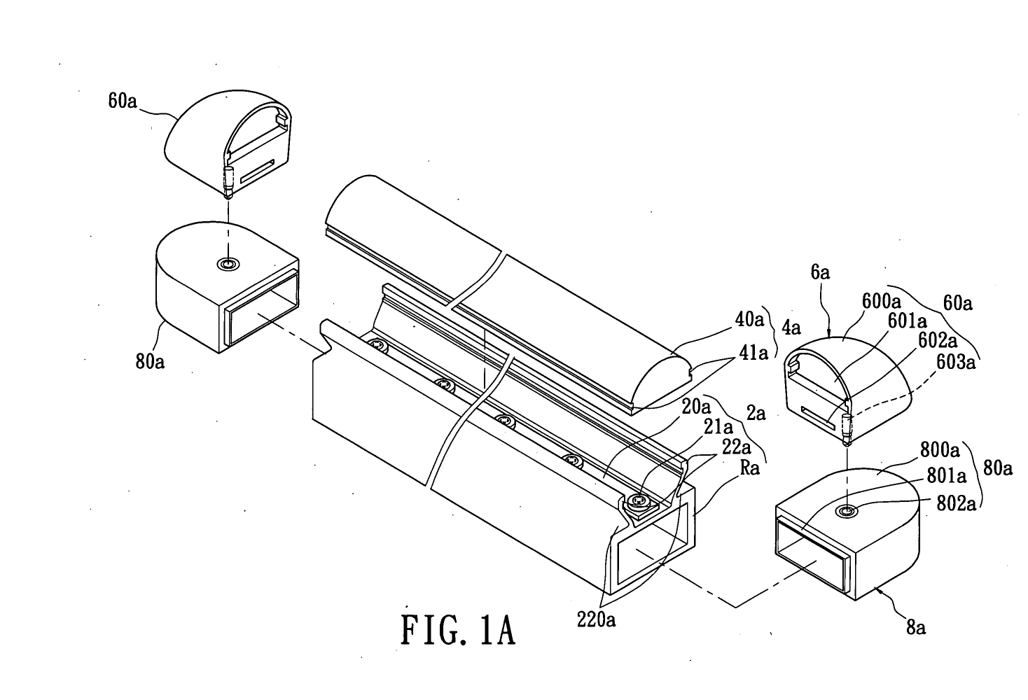

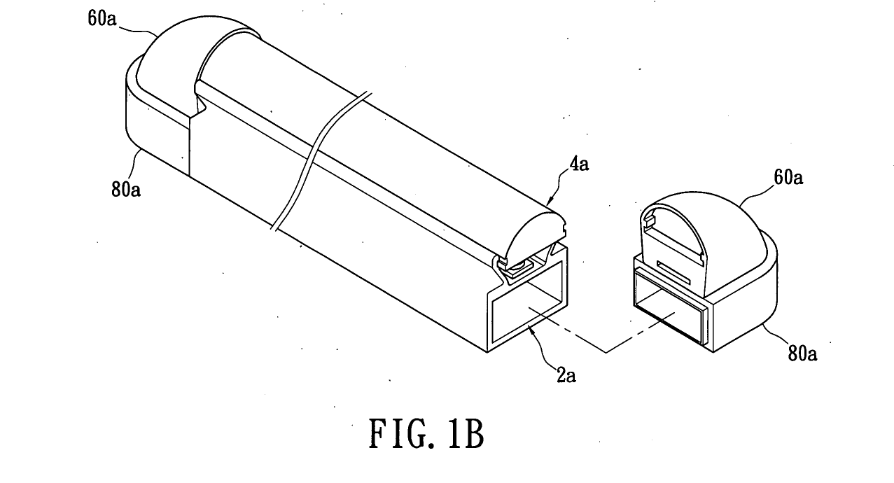

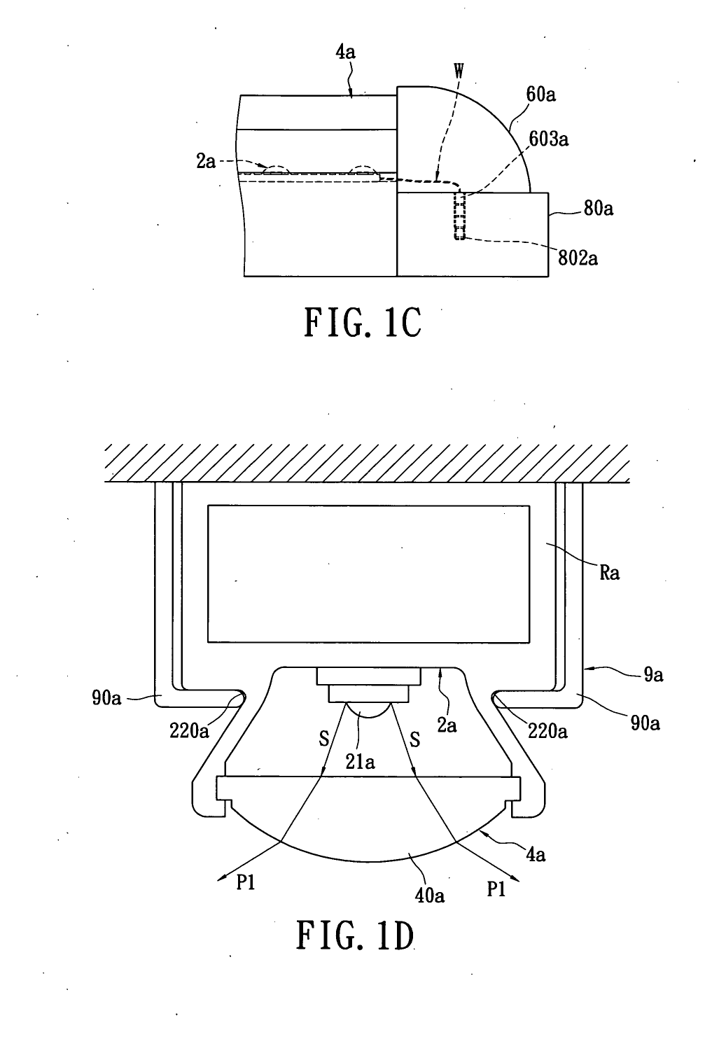

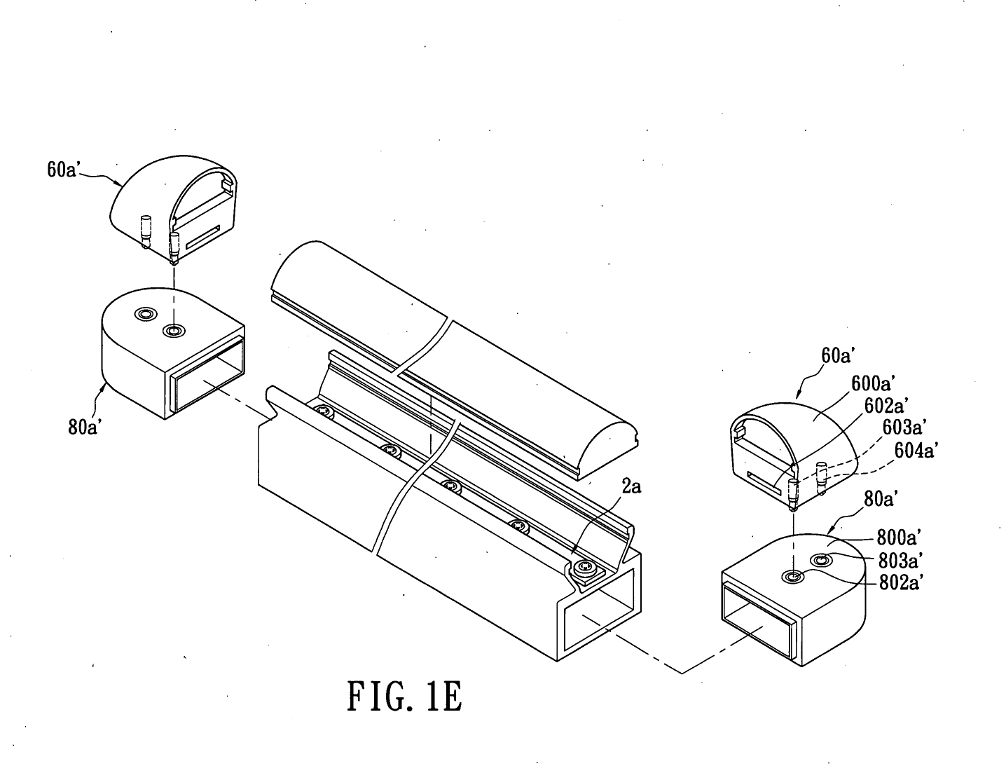

Referring to FIGS. 1A to 1D, the first embodiment of the present invention provides a custom assembly light-emitting module using plugs and jacks for obtaining vertical electrical connections, including: a light-emitting unit 2a, a lens unit 4a, a plug unit 6a and a jack unit 8a.

The light-emitting unit 2a has a circuit substrate 20a, a retaining structure Ra disposed on a bottom side of the circuit substrate 20a for mating with the jack unit 8a, a plurality of light-emitting elements 21a electrically disposed on the circuit substrate 20a, and two first retaining structures 22a extended upwards from the bottom side of the circuit substrate 20a respectively (the two first retaining structures 22a are respectively extended upwards from two opposite lateral sides of the light-emitting unit 2a). Each first retaining structure 21a has a concave retaining portion 220a formed on its outside. In addition, the space, the color, the number and the power of the light-emitting elements 21a of the light-emitting unit 2a can be changed according to different user requirements.

The lens unit 4a has a lens 40a and two second retaining structures 41a respectively formed on two opposite lateral sides of the lens 40a. The two retaining structures 41a correspond to the two first retaining structures 22a respectively. Hence, the lens unit 4a is detachably disposed above the light-emitting unit 2a by matching the two first retaining structures 22a and the two second retaining structures 41a. In the first embodiment, the two first retaining structures 22a are two first sliding grooves facing each other, and the two second retaining structures 41a are two second sliding grooves in opposite direction to each other. The two first sliding grooves and the two second sliding grooves are matched to slide in each other. However, the matching relation between the two first sliding grooves and the two second sliding grooves is just an example. The lens unit 4a can be detachably disposed above the light-emitting unit 2a by any matching method. In other words, the lens unit 4a can be detachably combined with the light-emitting unit 2a.

In addition, the plug unit 6a disposed beside one side of the lens unit 4a and electrically connected with the light-emitting unit 2a (as shown in FIG. 1C). The plug unit 6a has two plug connectors 60a. Each plug connector 60a has a plug body 600a, a first receiving space 601a formed in the plug body 600a for receiving one part of the lens unit 4a, a second receiving space 602a formed in the plug body 600a, and at least one plug pin 603a projected downwards from a bottom side of the plug body 600a. Moreover, the light-emitting unit 2a is electrically connected with one side of the plug pin 603a by at least one wire W or any conductive element passing through the second receiving space 602a (as shown in FIG. 1C).

Furthermore, the jack unit 8a is disposed on a bottom side of the plug unit 6a and is electrically connected with the plug unit 6a. The jack unit 8a has two jack connectors 80a respectively corresponding to the two plug connectors 60a. Each jack connector 80a has a jack body 800a, a retaining portion 801a formed on one side of the jack body 800a for mating with the retaining structure Ra, and at least one jack hole 802a disposed in the jack body 800a for electrically receiving the corresponding plug pin 603a. In the first embodiment, the retaining portion 801a is received and retained in the retaining structures Ra of the light-emitting unit 2a.

Referring to FIG. 1D, the light-emitting unit 2a is inverted and retained in a hooking unit 9a by the two concave retaining portions 220a mating with the hooking unit 9a. For example, when a user wants to place the custom assembly light-emitting module using plugs and jacks for obtaining vertical electrical connections of the present invention on a ceiling (or on a wall or on any object), the light-emitting unit 2a can be inverted and retained between two hooking structures 90a of the hooking unit 9a by matching the two concave retaining portions 220a and the hooking structures 90a fixed on the ceiling. The retaining structure Ra is hidden in the hooking unit 9a, and the lens 40a is exposed out of the hooking unit 9a. Hence, the light beams S generated by the light-emitting elements 21a pass through the lens 40a and generate upwards projecting light beams P1 with predetermined light-projecting angles so as to provide the brightness required by the different user requirements. In addition, the present invention can generate different light-projecting angles due to the replacement of the lens 40a.

Referring to FIG. 1E, each plug connector 60a′ has two plug pins (603a′, 604a′) projected downwards from a bottom side of the plug body 600a′. Moreover, the light-emitting unit 2a is electrically connected with one side of the two plug pins (603a′, 604a′) by at least one wire or any conductive element passing through the second receiving space 602a′. Furthermore, each jack connector 80a′ has two jack holes (802a′, 803a?) disposed in the jack body 800a′ for electrically receiving the corresponding two plug pin (603a′, 604a′).

Therefore, the light-emitting frequency, the light-emitting intensity or the color variation of the light-emitting unit 2a may be adjusted by matching the two plug pins (603a′, 604a′) and the two jack holes (802a′, 803a′) in order to generate various light-emitting effects. However, above-mentioned number of the plug pins (603a′, 604a′) and jack holes (802a′, 803a′) is just an example. The present invention can use many plug pins to mate with many jack holes.

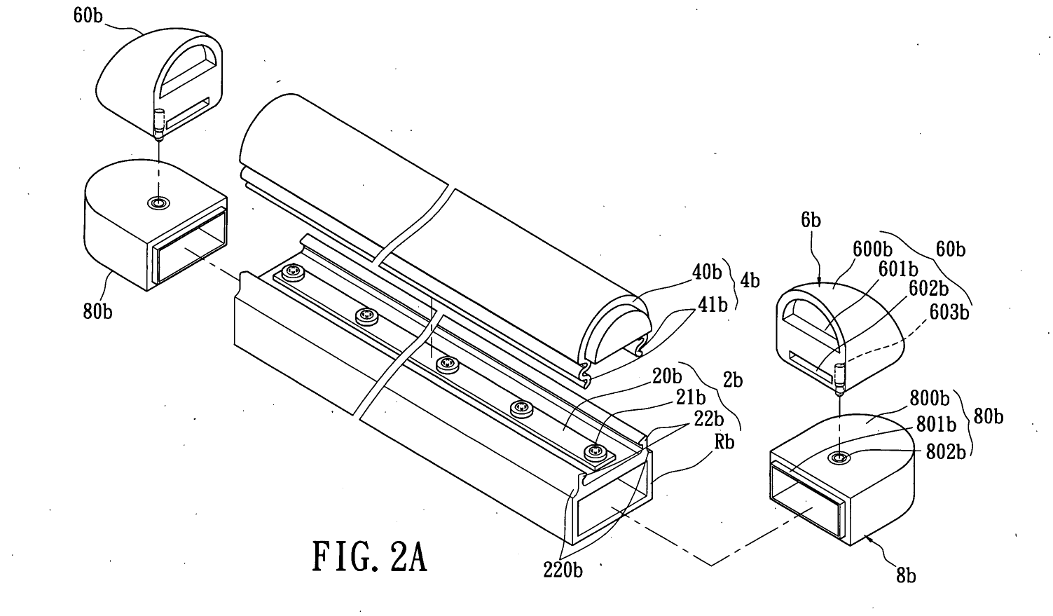

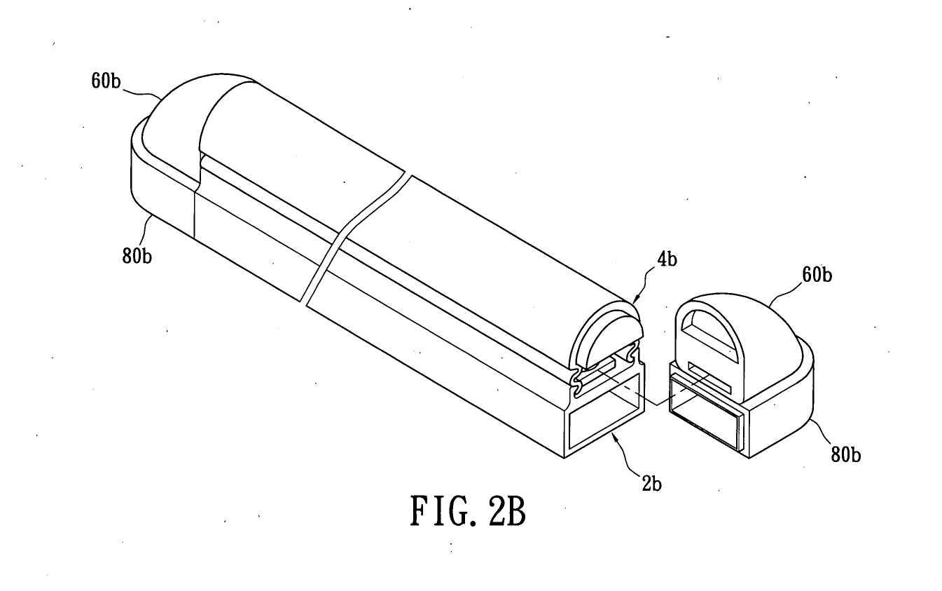

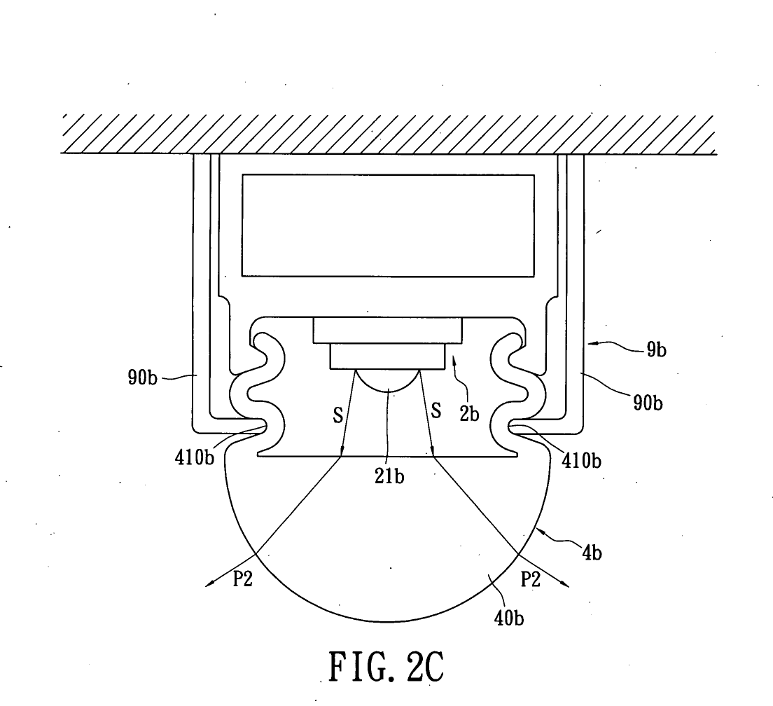

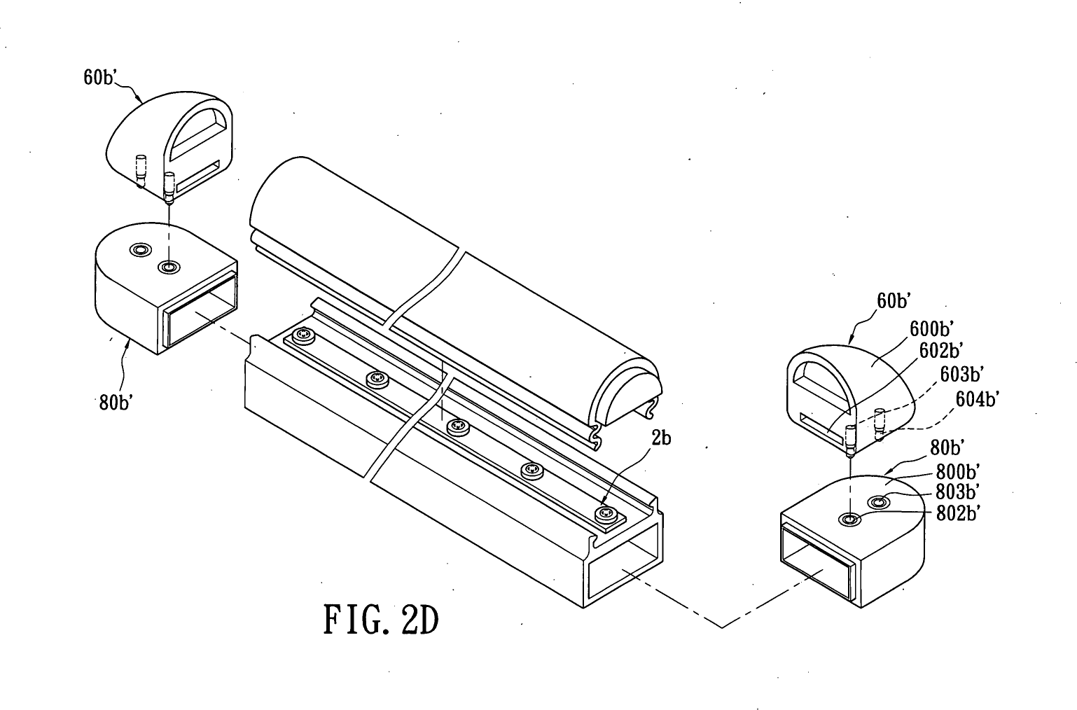

Referring to FIGS. 2A to 2C, the second embodiment of the present invention provides a custom assembly light-emitting module using plugs and jacks for obtaining vertical electrical connections, including: a light-emitting unit 2b, a lens unit 4b, a plug unit 6b and a jack unit 8b.

The light-emitting unit 2b has a circuit substrate 20b, a retaining structure Rb disposed on a bottom side of the circuit substrate 20b for mating with the jack unit 8b, a plurality of light-emitting elements 21b electrically disposed on the circuit substrate 20b, and two first retaining structures 22b extended upwards from the bottom side of the circuit substrate 20b respectively (the two first retaining structures 22b are respectively extended upwards from two opposite lateral sides of the light-emitting unit 2b). In addition, the space, the color, the number and the power of the light-emitting elements 21b of the light-emitting unit 2b can be changed according to different user requirements.

The lens unit 4b has a lens 40b and two second retaining structures 41b respectively extended downwards from two opposite lateral sides of the lens 40b. Each second retaining structure 41b has a concave retaining portion 410b formed on its outside. The two second retaining structures 41b correspond to the two first retaining structures 22b respectively. Hence, the lens unit 4b is detachably disposed above the light-emitting unit 2b by matching the two first retaining structures 22b and the two second retaining structures 41b. In the second embodiment, the two first retaining structures 22b are two first sliding grooves facing each other, the two second retaining structures 41b are two second sliding grooves in opposite direction to each other, and the two first sliding grooves and the two second sliding grooves are matched to slide in each other. However, the matching relation between the two first sliding grooves and the two second sliding grooves is just an example. The lens unit 4b can be detachably disposed above the light-emitting unit 2b by any matching method. In other words, the lens unit 4b can be detachably combined with the light-emitting unit 2b.

In addition, the plug unit 6b disposed beside one side of the lens unit 4b and electrically connected with the light-emitting unit 2b. The plug unit 6b has two plug connectors 60b. Each plug connector 60b has a plug body 600b, a first receiving space 601b formed in the plug body 600b for receiving one part of the lens unit 4b, a second receiving space 602b formed in the plug body 600b, and at least one plug pin 603b projected downwards from a bottom side of the plug body 600b. Moreover, the light-emitting unit 2b is electrically connected with one side of the plug pin 603b by at least one wire or any conductive element passing through the second receiving space 602b.

Furthermore, the jack unit 8b is disposed on a bottom side of the plug unit 6b and is electrically connected with the plug unit 6b. The jack unit 8b has two jack connectors 80b respectively corresponding to the two plug connectors 60b. Each jack connector 80b has a jack body 800b, a retaining portion 801b formed on one side of the jack body 800b for mating with the retaining structure Rb, and at least one jack hole 802b disposed in the jack body 800b for electrically receiving the corresponding plug pin 603b. In the second embodiment, the retaining portion 801b is received and retained in the retaining structures Rb of the light-emitting unit 2b.

Referring to FIG. 2C, the lens unit 4b is inverted and retained under a hooking unit 9b by the two concave retaining portions 410b matching with the hooking unit 9b. For example, when a user wants to place the custom assembly light-emitting module using plugs and jacks for obtaining vertical electrical connections of the present invention on a ceiling (or on a wall or on any object), the light-emitting unit 2b can be inverted and retained between two hooking structures 90b of the hooking unit 9b by matching the two concave retaining portions 410b and the hooking structures 90b fixed on the ceiling. The light-emitting unit 2b is hidden in the hooking unit 9b, and the lens 40b is exposed out of the hooking unit 9b. Hence, the light beams S generated by the light-emitting elements 21b pass through the lens 40b and generate upwards projecting light beams P2 with predetermined light-projecting angles, so that the light beams P2 is available to provide brightness required by the different user requirements. In addition, the present invention can generate different light-projecting angles due to the replacement of the lens 40b.

Referring to FIG. 2D, each plug connector 60b′ has two plug pins (603b′, 604b′) projected downwards from a bottom side of the plug body 600b′. Moreover, the light-emitting unit 2b is electrically connected with one side of the two plug pins (603b′, 604b′) by at least one wire or any conductive element passing through the second receiving space 602b′. Furthermore, each jack connector 80b′ has two jack holes (802b′, 803b′) disposed in the jack body 800b′ for electrically receiving the corresponding two plug pin (603b′, 604b′).

Therefore, the light-emitting frequency, the light-emitting intensity or the color variation of the light-emitting unit 2b may be adjusted by matching the two plug pins (603b′, 604b′) and the two jack holes (802b′, 803b′) and to generate various light-emitting effects. However, above-mentioned number of the plug pins (603b′, 604b′) and jack holes (802b′, 803b′) is just an example. The present invention can use many plug pins to mate with many jack holes.

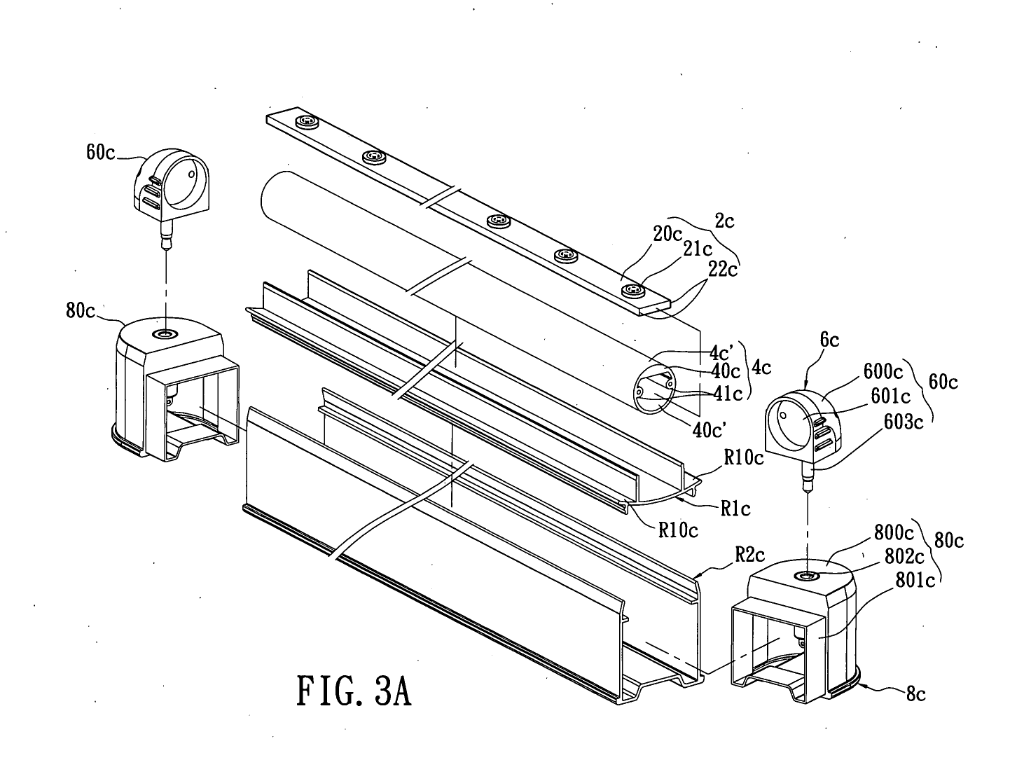

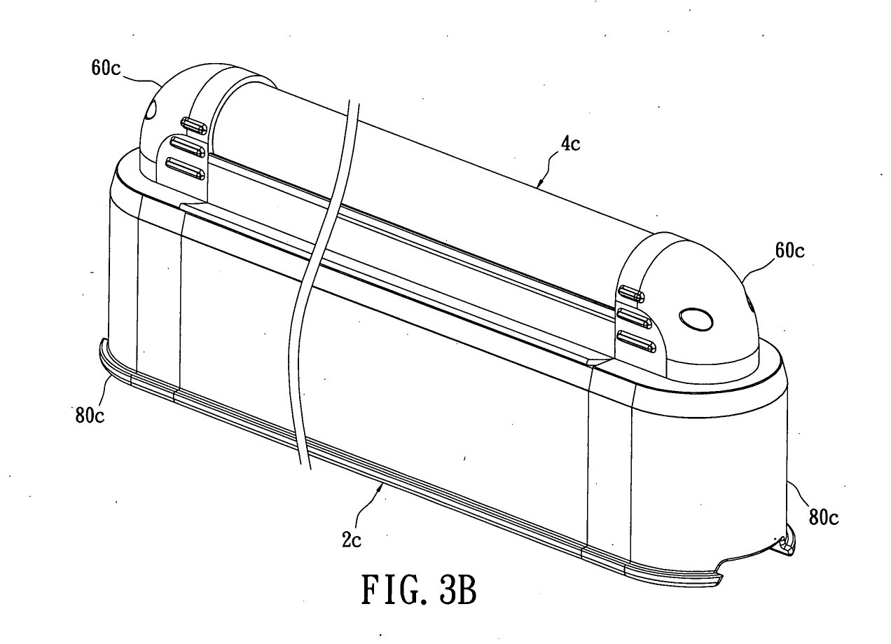

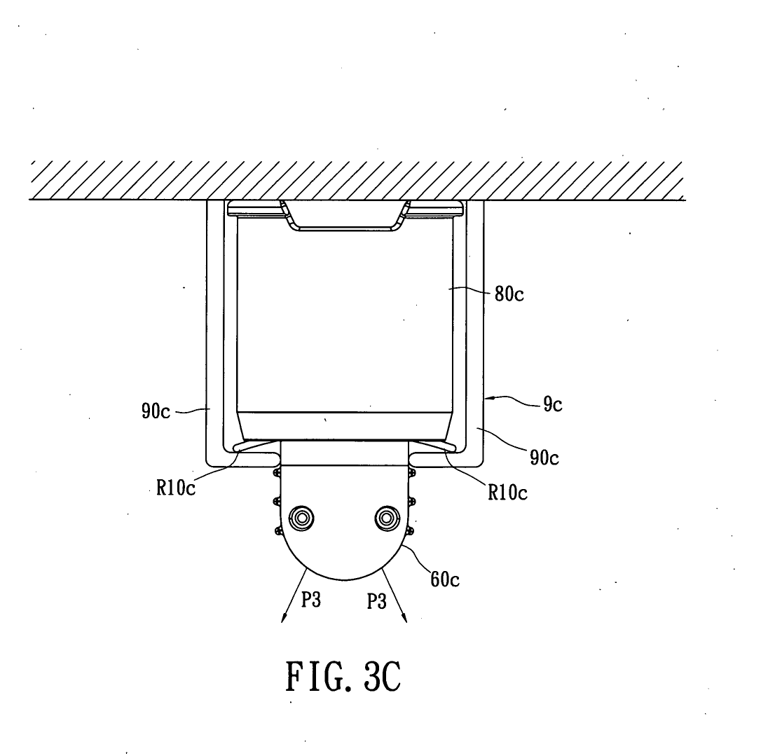

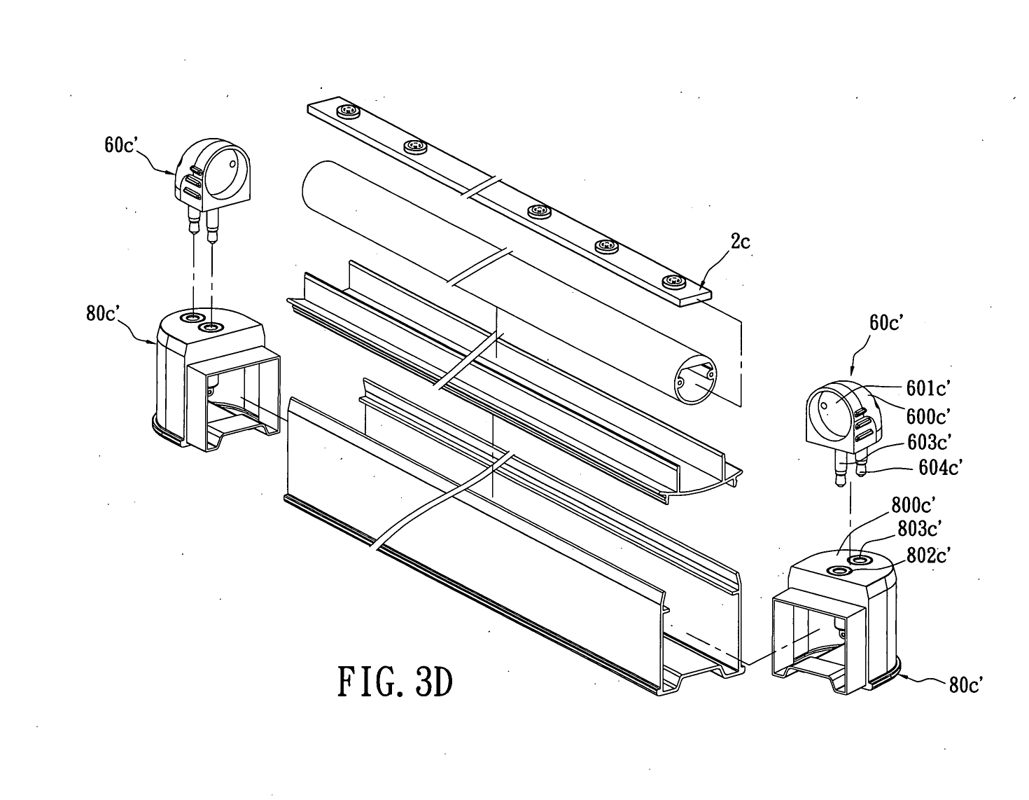

Referring to FIGS. 3A to 3C, the third embodiment of the present invention provides a custom assembly light-emitting module using plugs and jacks for obtaining vertical electrical connections, including: a light-emitting unit 2c, a lens unit 4c, a first retaining seat R1c, a second retaining seat R2c, a plug unit 6c and a jack unit 8c.

The light-emitting unit 2c is retained on the first retaining seat R1c, and the light-emitting unit 2c has a circuit substrate 20c, a plurality of light-emitting elements 21c electrically disposed on the circuit substrate 20c, and two first retaining structures 22c respectively disposed on two opposite lateral side of the circuit substrate 20c. In addition, the space, the color, the number and the power of the light-emitting elements 21c of the light-emitting unit 2c can be changed according to different user requirements.

The lens unit 4c has a hollow transparent structure 4c′, a lens 40c integratedly with the hollow transparent structure 4c′, and two second retaining structures 41c facing each other and disposed on an inner surface 40c′ of the hollow transparent structure 4c′ (the two second retaining structures 41c are disposed in the hollow transparent structure 4c′, and the light-emitting unit 2c is detachably disposed in the hollow transparent structure 4c′). The lens 40c is disposed on a top side of the hollow transparent structure 4c′ and is disposed above the light-emitting unit 2c. The two second retaining structures 41c correspond to the two first retaining structures 22c respectively. Hence, the lens unit 4c is detachably disposed in the hollow transparent structure 4c′ by matching the two first retaining structures 22c and the two second retaining structures 41c. In the third embodiment, the two first retaining structures 22c are two first sliding grooves facing each other, and the two second retaining structures 41c are two second sliding grooves in opposite direction to each other and are disposed on an inner surface of the hollow transparent structure 4c′. The two first sliding grooves and the two second sliding grooves are matched to slide in each other.

The first retaining seat R1c is disposed under the hollow transparent structure 4c′, and the first retaining seat R1c has two concave retaining portions R10c formed on its two opposite lateral side. The second retaining seat R2c is disposed under the first retaining seat R1c. The hollow transparent 4c′ is retained on the first retaining seat R1c, and the first retaining seat R1c is retained on the second retaining seat R2c.

In addition, the plug unit 6c is disposed beside one side of the lens unit 4c and electrically connected with the light-emitting unit 2c. The plug unit 6c has two plug connectors 60c. Each plug connector 60c has a plug body 600c, a first receiving space 601c formed in the plug body 600c for receiving one part of the lens unit 4c, and at least one plug pin 603c projected downwards from a bottom side of the plug body 600c. Moreover, the light-emitting unit 2c is electrically connected with one side of the plug pin 603c by at least one wire or any conductive element passing through the first receiving space 601c.

Furthermore, the jack unit 8c is disposed on a bottom side of the plug unit 6c and is electrically connected with the plug unit 6c. The jack unit 8c has two jack connectors 80c respectively corresponding to the two plug connectors 60c. Each jack connector 80c has a jack body 800c, a retaining portion 801c formed on one side of the jack body 800c for mating with the second retaining seat R2c, and at least one jack hole 802c disposed in the jack body 800c for electrically receiving the corresponding plug pin 603c. In the third embodiment, the retaining portion 801c is received and retained in the second retaining seat R2c of the light-emitting unit 2c.

Referring to FIG. 3C, the lens unit 4c is inverted and retained under a hooking unit 9c by the two concave retaining portions R10c matching with the hooking unit 9c. For example, when a user wants to place the custom assembly light-emitting module using plugs and jacks for obtaining vertical electrical connections of the present invention on a ceiling (or on a wall or on any object), the light-emitting unit 2c can be inverted and retained between two hooking structures 90c of the hooking unit 9c by matching the two concave retaining portions R10c and the hooking structures 90c fixed on the ceiling. Hence, the light beams generated by the light-emitting elements 21c pass through the lens 40c and generate upwards projecting light beams P3 with predetermined light-projecting angles, so that the light beams P3 can provide the brightness required by the different user requirements. In addition, the present invention can generate different light-projecting angles due to the replacement of the lens 40c.

Referring to FIG. 3D, each plug connector 60c′ has two plug pins (603c′, 604c′) projected downwards from a bottom side of the plug body 600c′. Moreover, the light-emitting unit 2c is electrically connected with one side of the two plug pins (603c′, 604c′) by at least one wire or any conductive element passing through the second receiving space 602c′. Furthermore, each jack connector 80c′ has two jack holes (802c′, 803c′) disposed in the jack body 800c′ in order to electrically receive the corresponding two plug pin (603c′, 604c′).

Therefore, the light-emitting frequency, the light-emitting intensity or the color variation of the light-emitting unit 2c may be adjusted by matching the two plug pins (603c′, 604c′) and the two jack holes (802c′, 803c′) in order to generate various light-emitting effects. However, above-mentioned number of plug pin and jack hole is just an example. The present invention can use many plug pins to mate with many jack holes.

In conclusion, the light-emitting unit is replaceable according to different light-emitting effects, and the lens unit is replaceable according to different light-projecting angles. Hence, the present invention has the following advantages:

1. The light-emitting unit is replaceable, so that the space, the color, the number and the power of the light-emitting elements can be changed according to different user requirements.

2. The lens unit is replaceable (the lens unit is detachably disposed above the light-emitting unit by matching the two first retaining structures and the two second retaining structures), so that the lens can be changed according to the different light-projecting angles required by the different user requirements.

3. In the first embodiment, the light-emitting unit 2a is inverted and retained in a hooking unit 9a by the two concave retaining portions 220a mating with the hooking unit 9a. Hence, the light beams S generated by the light-emitting elements 21a pass through the lens 40a and generate upwards projecting light beams P1 with predetermined light-projecting angles, so that the light beams can provide brightness required by the different user requirements.

4. In the second embodiment, the lens unit 4b is inverted and retained under a hooking unit 9b by the two concave retaining portions 410b matching with the hooking unit 9b. Hence, the light beams S generated by the light-emitting elements 21b pass through the lens 40b and generate upwards projecting light beams P3 with predetermined light-projecting angles, so that the light beams can provide brightness required by the different user requirements.

5. In the third embodiment, the two second retaining structures 41c correspond to the two first retaining structures 22c respectively. Hence, the lens unit 4c is detachably disposed in the hollow transparent structure 4c′ by matching the two first retaining structures 22c and the two second retaining structures 41c.

6. The present invention has vertical electrical connections by matching the plug unit (the plug pins) and the jack unit (the jack pins).

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A custom assembly light-emitting module using plugs and jacks for obtaining vertical electrical connections, comprising:
a light-emitting unit;
a lens unit detachably combined with the light-emitting unit;
a plug unit disposed beside one side of the lens unit and electrically connected with the light-emitting unit; and
a jack unit disposed on a bottom side of the plug unit and electrically connected with the plug unit.

2. The custom assembly light-emitting module as claimed in claim 1, wherein the light-emitting unit has two first retaining structures respectively extending upwards from two opposite lateral sides thereof, the lens unit has a lens and two second retaining structures respectively formed on two opposite lateral sides of the lens, and the lens unit is detachably disposed above the light-emitting unit by matching the two first retaining structures and the two second retaining structures.

3. The custom assembly light-emitting module as claimed in claim 2, wherein the light-emitting unit has a circuit substrate, a retaining structure disposed on a bottom side of the circuit substrate for mating with the jack unit, and a plurality of light-emitting elements electrically disposed on the circuit substrate, the two first retaining structures are respectively extending upwards from a bottom side of the circuit substrate.

4. The custom assembly light-emitting module as claimed in claim 3, wherein the plug unit has two plug connectors, each plug connector has a plug body, a first receiving space formed in the plug body for receiving one part of the lens unit, a second receiving space formed in the plug body, and at least one plug pin projected downwards from a bottom side of the plug body, the light-emitting unit is electrically connected with one side of the plug pin.

5. The custom assembly light-emitting module as claimed in claim 4, wherein the jack unit has two jack connectors respectively corresponding to the two plug connectors, each jack connector has a jack body, a retaining portion formed on one side of the jack body for mating with the retaining structure, and at least one jack hole disposed in the jack body for electrically receiving the corresponding plug pin.

6. The custom assembly light-emitting module as claimed in claim 2, wherein the two first retaining structures are two first sliding grooves facing each other, the two second retaining structures are two second sliding grooves in opposite direction to each other, and the two first sliding grooves and the two second sliding grooves are matched to slide in each other.

7. The custom assembly light-emitting module as claimed in claim 2, wherein each first retaining structure has a concave retaining portion formed on its outside, and the light-emitting unit is inverted and retained in a hooking unit by the two concave retaining portions mating with the hooking unit.

8. The custom assembly light-emitting module as claimed in claim 1, wherein the light-emitting unit has two first retaining structures disposed on two opposite lateral sides thereof, the lens unit has a lens and two second retaining structures respectively extending downwards from two opposite lateral sides of the lens, and the lens unit is detachably disposed above the light-emitting unit by matching the two first retaining structures and the two second retaining structures.

9. The custom assembly light-emitting module as claimed in claim 8, wherein the light-emitting unit has a circuit substrate, a retaining structure disposed on a bottom side of the circuit substrate for mating with the jack unit, and a plurality of light-emitting elements electrically disposed on the circuit substrate, and the two first retaining structures are respectively extending upwards from a bottom side of the circuit substrate.

10. The custom assembly light-emitting module as claimed in claim 9, wherein the plug unit has two plug connectors, each plug connector has a plug body, a first receiving space formed in the plug body for receiving one part of the lens unit, a second receiving space formed in the plug body, and at least one plug pin projected downwards from a bottom side of the plug body, the light-emitting unit is electrically connected with one side of the plug pin.

11. The custom assembly light-emitting module as claimed in claim 10, wherein the jack unit has two jack connectors respectively corresponding to the two plug connectors, each jack connector has a jack body, a retaining portion formed on one side of the jack body for mating with the retaining structure, and at least one jack hole disposed in the jack body for electrically receiving the corresponding plug pin.

12. The custom assembly light-emitting module as claimed in claim 8, wherein the two first retaining structures are two first sliding grooves facing each other, the two second retaining structures are two second sliding grooves in opposite direction to each other, and the two first sliding grooves and the two second sliding grooves are matched to slide in each other.

13. The custom assembly light-emitting module as claimed in claim 8, wherein each second retaining structure has a concave retaining portion formed on its outside, and the lens unit is inverted and retained under a hooking unit by the two concave retaining portions mating with the hooking unit.

14. The custom assembly light-emitting module as claimed in claim 1, wherein the light-emitting unit has two first retaining structures are formed on two opposite lateral sides thereof, the lens unit has a hollow transparent structure and a lens integratedly with the hollow transparent structure, two second retaining structures are disposed in the hollow transparent structure, and the light-emitting unit is detachably disposed in the hollow transparent structure.

15. The custom assembly light-emitting module as claimed in claim 14, wherein the lens is disposed on a top side of the hollow transparent structure and is disposed above the light-emitting unit, the two second retaining structures face each other and are disposed on an inner surface of the hollow transparent structure.

16. The custom assembly light-emitting module as claimed in claim 14, further comprising: a first retaining seat disposed under the hollow transparent structure and a second retaining seat disposed under the first retaining seat, wherein the hollow transparent is retained on the first retaining seat, and the first retaining seat is retained on the second retaining seat.

17. The custom assembly light-emitting module as claimed in claim 16, wherein the first retaining seat has two concave retaining portions formed on its two opposite lateral side, and the lens unit is inverted and retained under a hooking unit by the two concave retaining portions mating with the hooking unit.

18. The custom assembly light-emitting module as claimed in claim 14, wherein the light-emitting unit has a circuit substrate and a plurality of light-emitting elements electrically disposed on the circuit substrate, and the two first retaining structures are respectively disposed on two opposite lateral side of the circuit substrate.

19. The custom assembly light-emitting module as claimed in claim 18, wherein the plug unit has two plug connectors, each plug connector has a plug body, a first receiving space formed in the plug body for receiving one part of the lens unit, and at least one plug pin projected downwards from a bottom side of the plug body, the light-emitting unit is electrically connected with one side of the plug pin.

20. The custom assembly light-emitting module as claimed in claim 19, wherein the jack unit has two jack connectors respectively corresponding to the two plug connectors, each jack connector has a jack body, a retaining portion formed on one side of the jack body for mating with the second retaining seat, and at least one jack hole disposed in the jack body in order to electrically receive the corresponding plug pin.
